(19) United States
(12) Patent Application Publication
(10) Pub. No.: US 2008/0231578 A1
(43) Pub. Date: Sep. 25, 2008

(54) LVDS display system

(75) Inventors: Barry Johnson, Thousand Oaks, CA (US); Kurt Zierhut, Camarillo, CA (US)

Correspondence Address: MCDERMOTT WILL & EMERY LLP, 18191 VON KARMAN AVE., SUITE 500, IRVINE, CA, 92612-7108, US

(73) Assignee: Haas Automation, Inc., Oxnard, CA (US)

(21) Appl. No.: 11/725,382

(22) Filed: Mar. 19, 2007

(51) Int. Cl. G09G 3/36

(52) U.S. Cl. 345/98

(57) ABSTRACT

A display system comprises a controller having a plurality of TTL inputs and a corresponding plurality of LVDS output pairs, the controller configured to receive display data comprising a first plurality of TTL signals at the plurality of TTL inputs, to convert each of the first plurality of TTL signals to a corresponding LVDS signal, and to output each of the plurality of LVDS signals at one of the plurality of LVDS output pairs. The system further comprises a bus operatively coupled with the controller, the bus having a plurality of parallel channels, each channel being configured to carry one of the plurality of LVDS signals, a LVDS-to-TTL converter operatively coupled with the bus, the LVDS-to-TTL converter being configured to receive the plurality of LVDS signals from the bus and to convert each of the plurality of LVDS signals to a corresponding TTL signal, and a display configured to receive the plurality of TTL signals from the LVDS-to-TTL converter.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention generally relates to display systems, and, in particular, relates to display systems in which low voltage differential signaling is used to transmit display data.

### BACKGROUND OF THE INVENTION

One approach to providing video data over long distances involves using serial digital data for transmission by a cable. In this approach, the video data is converted to a serial data stream and provided over a long-distance cable. In order to provide a high enough bit rate for acceptable video, this approach requires a very high clock rate, and places complex and costly restrictions on the cable used (e.g., pair-to-pair skew).

Another approach to providing video data over long distances involves using analog video. In this approach, digital video data is converted to an analog signal, transmitted to a display, where it may need to be re-converted to a digital format again (e.g., for a fixed-pixel display). In this approach, transmitting the data in an analog format over long distances renders the data subject to greater noise interference.

### SUMMARY OF THE INVENTION

The present invention solves the foregoing problems by providing a display system that can transmit video data over long distances without the need for expensive cabling or the noisy analog conversion of other approaches. In the system of the present invention, display data is transmitted across a parallel bus in a low voltage differential signaling (“LVDS”) format to a differential receiver circuit card assembly, where the LVDS signals are converted into a transistor-to-transistor logic (“TTL”) format before being provided to a display, such as a digital liquid crystal display (“LCD”).

According to one embodiment of the present invention, a display system comprises a controller having a plurality of TTL inputs and a corresponding plurality of LVDS output pairs. The controller is configured to receive display data comprising a first plurality of TTL signals at the plurality of TTL inputs, to convert each of the first plurality of TTL signals to a corresponding LVDS signal, and to output each of the plurality of LVDS signals at one of the plurality of LVDS output pairs. The system further comprises a bus operatively coupled with the controller. The bus has a plurality of parallel channels, each channel being configured to carry one of the plurality of LVDS signals. The system further comprises a LVDS-to-TTL converter operatively coupled with the bus, the LVDS-to-TTL converter being configured to receive the plurality of LVDS signals from the bus and to convert each of the plurality of LVDS signals to a corresponding TTL signal in a second plurality of TTL signals. The system further comprises a display configured to receive the second plurality of TTL signals from the LVDS-to-TTL converter.

According to another embodiment of the present invention, a display system comprises a controller having a plurality of TTL inputs and a corresponding plurality of LVDS output pairs, the controller configured to receive display data comprising a first plurality of TTL signals at the plurality of TTL inputs, to convert each of the first plurality of TTL signals to a corresponding LVDS signal, and to output each of the plurality of LVDS signals at one of the plurality of LVDS output pairs. The system further comprises a bus having a plurality of parallel twisted cable pairs, each twisted cable pair being coupled with one of the plurality of output pairs and being configured to carry one of the plurality of LVDS signals. The system further comprises a LVDS-to-TTL converter including a plurality of LVDS input pairs, each LVDS input pair corresponding to and coupled with one of the plurality of parallel twisted cable pairs, the LVDS-to-TTL converter being configured to convert each of the plurality of LVDS signals to a corresponding TTL signal in a second plurality of TTL signals and to output the second plurality of TTL signals from a corresponding plurality of TTL outputs. The system further comprises a display configured to receive the second plurality of TTL signals from the LVDS-to-TTL converter.

According to another embodiment of the present invention, a method for displaying data comprises the steps of generating display data comprising a first plurality of TTL signals, converting each of the first plurality of TTL signals to a corresponding LVDS signal, transmitting each of the plurality of LVDS signals over a separate channel of a parallel bus with a plurality of parallel channels, receiving the plurality of LVDS signals from the bus with a TTL-to-LVDS converter, converting each of the plurality of LVDS signals to a corresponding TTL signal in a second plurality of TTL signals, and transmitting the second plurality of TTL signals from the LVDS-to-TTL converter to a display.

It is to be understood that both the foregoing summary of the invention and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a block diagram illustrating a display system according to one embodiment of the present invention;

FIG. 2 illustrates a controller according to one embodiment of the present invention;

FIG. 3 illustrates a differential receiver according to one embodiment of the present invention;

FIG. 4 illustrates a differential receiver configured to interpolate color data according to one embodiment of the present invention;

FIG. 5 illustrates a differential receiver configured to serialize display data according to one embodiment of the present invention; and

FIG. 6 is a flowchart illustrating a method for displaying data according to one embodiment of the present invention.

### DETAILED DESCRIPTION OF THE INVENTION

In the following detailed description, numerous specific details are set forth to provide a full understanding of the present invention. It will be apparent, however, to one ordinarily skilled in the art that the present invention may be practiced without some of these specific details. In other instances, well-known structures and techniques have not been shown in detail to avoid unnecessarily obscuring the present invention.

Low voltage differential signaling (“LVDS”) is a low-swing differential signaling technology which enjoys numerous advantages over single-ended schemes. LVDS allows single channel data transmission at hundreds or even thousands of Megabits per second (“Mbps”). Its low swing and current-mode driver outputs create low noise and provide very low power consumption across a wide range of frequencies. Because LVDS is differential, two signal lines or traces must be used to convey information. Offsetting the cost increase of these additional traces, however, is increased noise tolerance (in the form of common-mode rejection). Noise that is coupled onto the interconnect is seen by the receivers as common mode modulations, and is rejected. Because the signal-to-noise rejection is thus improved, signal swing can be dropped to only a few hundred millivolts or less. This small swing (and the associated shorter rise time) allows for much faster data rates than other approaches.

In accordance with various embodiments of the present invention, LVDS is used to communicate display data over long distances using inexpensive, commonly-available cabling. As will be seen with reference to the specific embodiments illustrated in greater detail below, a system of the present invention may generate display data directly in an LVDS format, or may alternately convert display data to an LVDS format before transmitting it over a parallel bus to a remote differential receiver circuit card assembly (“CCA”), where it is converted to a transistor-transistor logic (“TTL”) format and provided to a display.

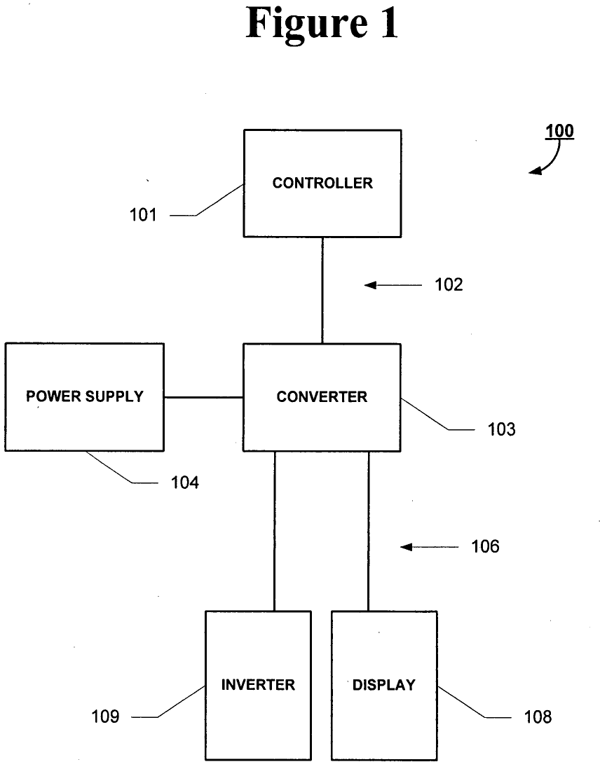

FIG. 1 illustrates a display system according to one embodiment of the present invention. Display system 100 includes a controller 101 configured to generate display data including a plurality of LVDS signals. The LVDS signals are communicated across a bus 102 with a separate channel for carrying each of the plurality of LVDS signals. In the present exemplary embodiment, each channel of bus 102 is a twisted pair of cables. The LVDS signals are received at a differential receiver CCA (hereinafter, “converter”) 103, which converts each of the LVDS signals to a corresponding TTL signal. Converter 103 is coupled by a data cable 106 to a liquid crystal display (“LCD”) 108, which receives the TTL signals and displays the display data. Converter 103 is further coupled to a power supply 104 and an inverter 109 (which may be part of LCD 108), whereby converter 103 receives power from power supply 104 and provides it to inverter 109 for lighting display 108.

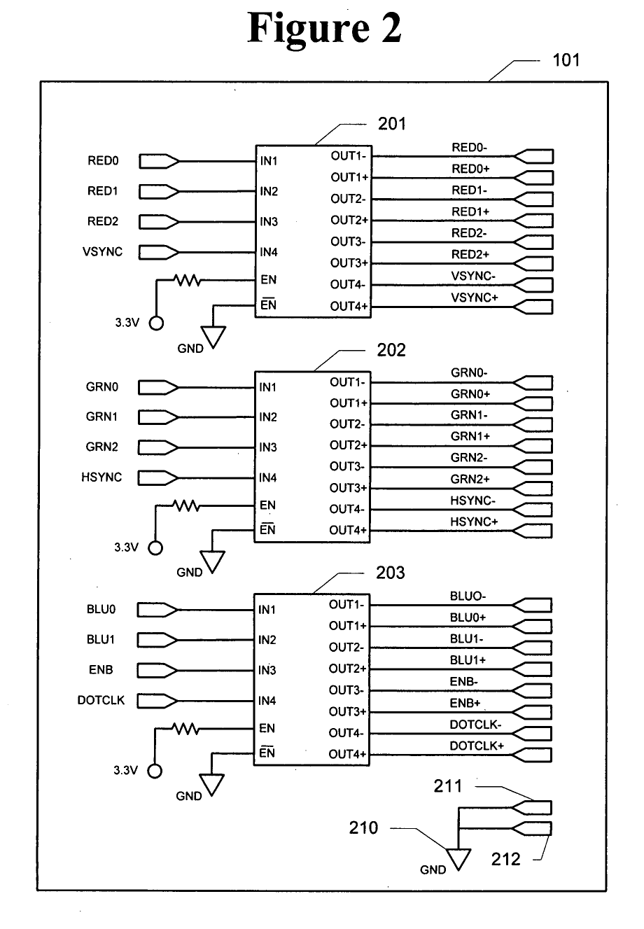

In some embodiments, controller 101 may generate the display data directly in an LVDS format. In alternate embodiments, however, controller 101 may generate the display data in a TTL format, and subsequently convert the TTL signals into LVDS signals for communicating over a parallel bus. FIG. 2 illustrates one such exemplary embodiment, in which controller 101 receives display data in TTL-formatted signals, and converts the display data into LVDS format using three LVDS drivers 201, 202 and 203. For example, in the present exemplary embodiment, a “3V LVDS Quad CMOS Differential Line Driver,” part number DS90LV031A from National Semiconductor Corporation is used to convert TTL signals to LVDS signals.

LVDS driver 201 receives four signals, labeled RED0, RED1, RED2 and VSYNC, and corresponding to three channels of red color data and the vertical sync information for the display. These signals are received at the inputs of LVDS driver 201 labeled IN1, IN2, IN3 and IN4, respectively. Also coupled with LVDS driver 201 are a 3.3V power trace and a ground trace. LVDS driver 201 receives the four signals RED0, RED1, RED2 and VSYNC, which are in a TTL format, and converts them to a LVDS format. As can be seen with reference to FIG. 2, being in a differential format, each LVDS signal requires two outputs on LVDS driver 201, indicated by the labels OUT1−, OUT1+, OUT2−, OUT2+, OUT3−, OUT3+, OUT4− AND OUT4+. Accordingly, the signal for RED0 (now in an LVDS format, and signified by the labels RED0− and RED0+) is communicated over two connectors which are coupled to OUT1− and OUT1+. The signals for RED1, RED2 and VSYNC are similarly communicated over two connectors each from their respective outputs on LVDS driver 201.

LVDS drivers 202 and 203 operate in a similar fashion as described above with respect to LVDS driver 201. In this regard, LVDS driver 202 outputs three channels of green color data (GRN0, GRN1 and GRN2) and horizontal sync information (HSYNC), while LVDS driver 203 outputs two channels of blue color data (BLU0 and BLU1), clock information (DOTCLK) and a display enable signal (ENB).

Accordingly, as can be seen with reference to FIG. 2, controller 101 outputs twelve LVDS signals, four of which are control signals (HSYNC, VSYNC, DOTCLK and ENB), while the remaining eight are color signals. Each of these signals is carried over a separate channel of parallel bus 102. In the present exemplary embodiment, each channel of parallel bus 102 includes a twisted pair of cables connecting controller 101 to converter 103.

Controller 101 further includes ground 210 and two outputs 211 and 212 for sharing a common ground between controller 101 and converter 103 over bus 102, as will be illustrated in greater detail below. As will be immediately apparent to those of skill in the art, FIG. 2 is a simplified schematic, omitting specific details not necessary for an understanding of the claimed invention. Accordingly, in various embodiments of the present invention, controller 101 may include additional components not illustrated herein, as well as alternate arrangements of the components illustrated in FIG. 2, or may omit components shown in FIG. 2.

While in the foregoing exemplary embodiment, controller 101 has been illustrated as generating display data in a TTL format and subsequently converting this data to a plurality of LVDS signals, the scope of the present invention is not limited to such an arrangement. Rather, in alternate embodiments, controller 101 may generate display data natively in an LVDS format, obviating the need for any converting. Moreover, while controller 101 is depicted as generating display data consisting of exactly twelve signals (four for control and eight for color), the scope of the present invention is not limited to such an arrangement. Rather, as will be apparent to one of skill in the art, the present invention has application to arrangements in which any number of channels of display data, including one, is communicated in an LVDS format to a display.

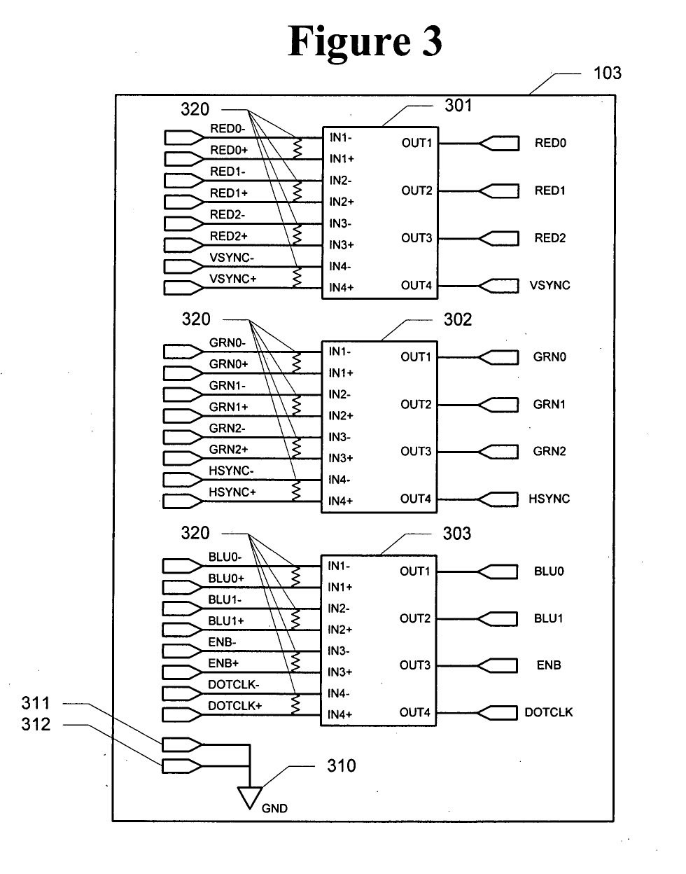

Turning to FIG. 3, converter 103 is illustrated according to one embodiment of the present invention. Converter 103 includes twelve pairs of inputs (labeled from top to bottom RED0−, RED0+, RED1−, . . . DOTCLK−, DOTCLK+) which correspond to the twelve LVDS signals generated by controller 101. Each pair of inputs is connected by a resistor 320. For example, in the present exemplary embodiment, each resistor 320 is a 100 ohm ⅛ watt resistor. Converter 103 further includes three LVDS receivers 301, 302 and 303 for receiving the twelve LVDS signals and converting each LVDS signal to a TTL format. For example, in the present exemplary embodiment, a “3V LVDS Quad CMOS Differential Line Receiver,” part number DS90LV048A from National Semiconductor Corporation is used to convert the LVDS signals to TTL format. LVDS receiver 301 includes four pairs of inputs (labeled IN1−, IN1+, IN2−, IN2+, IN3−, IN3+, IN4− and IN4+) which receive the LVDS signals for three channels of red color information and one vertical sync channel. LVDS receiver 301 converts these LVDS signals to a TTL format, and outputs the TTL format signals RED0, RED1, RED2 and VSYNC at outputs OUT1, OUT2, OUT3 and OUT4, respectively.

LVDS receivers 302 and 303 operate in a similar fashion as described above with respect to LVDS receiver 301. In this regard, LVDS receiver 302 converts three channels of green color data (GRN0, GRN1 and GRN2) and one channel of horizontal sync information (HSYNC) to TTL format, while LVDS receiver 303 converts two channels of blue color data (BLU0 and BLU1), one channel of clock information (DOTCLK) and a display enable signal (ENB) to TTL format.

Converter 103 further includes a ground 310 and two inputs 311 and 312 for sharing a common ground between converter 103 and controller 101 over bus 102. For example, bus 102 may be a thirteen channel bus having thirteen twisted pairs, twelve of which each carry an LVDS signal, and one of which is used to commonly ground controller 101 and converter 103.

As will be immediately apparent to those of skill in the art, FIG. 3 is a simplified schematic, omitting specific details not necessary for an understanding of the claimed invention. Accordingly, in various embodiments of the present invention, converter 103 may include additional components not illustrated herein, as well as alternate arrangements of the components illustrated in FIG. 3, or may omit components shown in FIG. 3.

While the foregoing exemplary embodiment has been described with reference to a bus 102 which includes twisted pairs of cables for carrying LVDS signals, the scope of the present invention is not limited to such an arrangement. Rather, as will be apparent to one of skill in the art, the present invention has application to any connectors or cables that may be used to carry electrical signals.

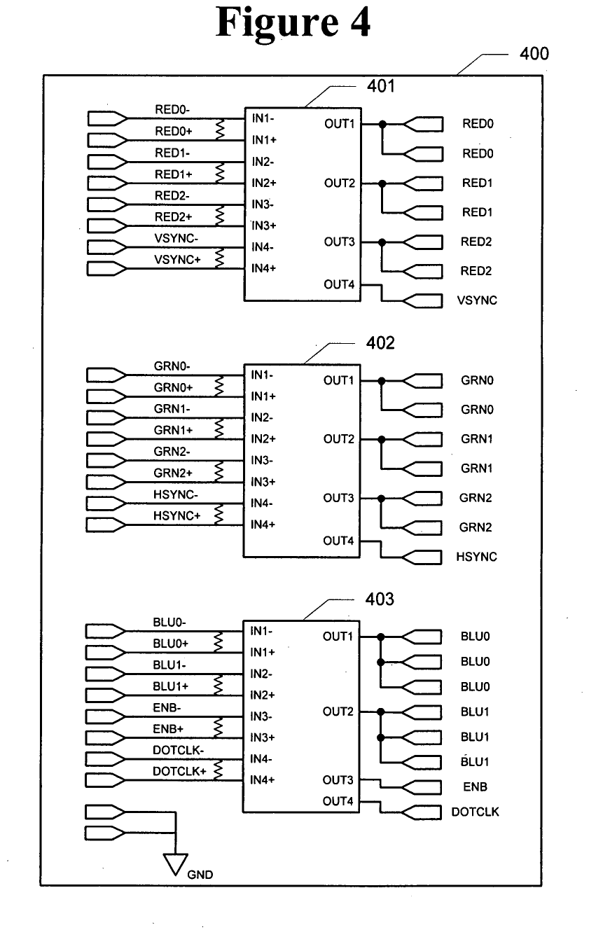

FIG. 4 illustrates a converter according to another embodiment of the present invention, in which TTL format output color information is interpolated before being provided to a display. Like converter 103 illustrated in FIG. 3, converter 400 includes twelve pairs of inputs which correspond to the twelve LVDS signals generated by a controller. Each pair of inputs is connected by a resistor. Converter 400 further includes three LVDS receivers 401, 402 and 403 for receiving the twelve LVDS signals and converting each LVDS signal to a TTL format.

Converter 400 differs from converter 103 described above in that converter 400 interpolates color data by providing additional outputs for each of the color channels. For example, the RED0 color channel is provided to two different outputs, as is each of RED1, RED2, GRN0, GRN1 and GRN2. Each of BLU0 and BLU1 is provided to three different outputs. In this manner, converter 400 can provide display data to a display which is configured to expect more channels of color information than are generated by controller 101.

As will be immediately apparent to those of skill in the art, FIG. 4 is a simplified schematic, omitting specific details not necessary for an understanding of the claimed invention. Accordingly, in various embodiments of the present invention, converter 400 may include additional components not illustrated herein, as well as alternate arrangements of the components illustrated in FIG. 4, or may omit components shown in FIG. 4.

While the foregoing exemplary embodiment has been described with reference to specific numbers of inputs and outputs, the scope of the present invention is not limited to such an arrangement. Rather, as will be apparent to one of skill in the art, the present invention has application to arrangements with any number of inputs and outputs, and in which only some of the color channels are interpolated, while others are not.

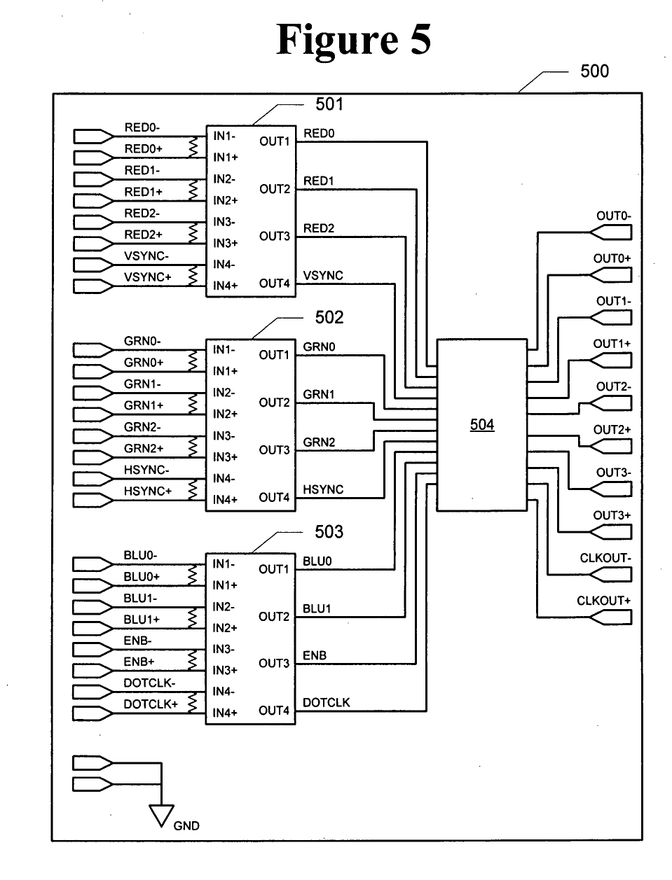

Turning to FIG. 5, a converter 500 which is configured to serialize the output TTL display data is illustrated according to another embodiment of the present invention. As some displays (e.g. LCD displays) are configured to accept display data formatted in a high speed serialized LVDS format, converter 500 includes circuitry for converting the input LVDS signals to corresponding TTL signals, which are then serialized and provided at a higher clock speed to a LCD display over a short connector (e.g. a twenty pin LCD display cable). Like converters 103 and 400 illustrated in FIGS. 3 and 4, respectively, converter 500 includes twelve pairs of inputs which correspond to the twelve LVDS signals generated by a controller. Each pair of inputs is connected by a resistor. Converter 500 further includes three LVDS receivers 501, 502 and 503 for receiving the twelve LVDS signals and converting each LVDS signal to a TTL format.

Converter 500 further includes circuitry 504 for serializing the TTL format display data. For example, in the present exemplary embodiment, a “LVDS Transmitter Flat Panel Display 85 MHz” chip, part number DS90C385A from National Semiconductor Corporation is used to convert the TTL signals RED0, RED1, RED2, VSYNC, GRN0, GRN1, GRN2, HSYNC, BLU0, BLU1 and DOTCLK to a high-speed, serialized LVDS format. In doing so, the clock rate of the TTL signals is increased to maintain the necessary data rate over fewer channels. Circuitry 504 has five pairs of outputs labeled OUT0−, OUT0+, OUT1−, OUT1+, OUT2−, OUT2+, OUT3−, OUT3+, CLKOUT− and CLKOUT+, respectively. While circuitry 504 is illustrated for simplicity with single inputs for each color channel, controller 500 may be configured to interpolate color data as described in greater detail above with reference to FIG. 4 prior to providing the data to circuitry 504.

As will be immediately apparent to those of skill in the art, FIG. 5 is a simplified schematic, omitting specific details not necessary for an understanding of the claimed invention. Accordingly, in various embodiments of the present invention, converter 500 may include additional components not illustrated herein, as well as alternate arrangements of the components illustrated in FIG. 5, or may omit components shown in FIG. 5.

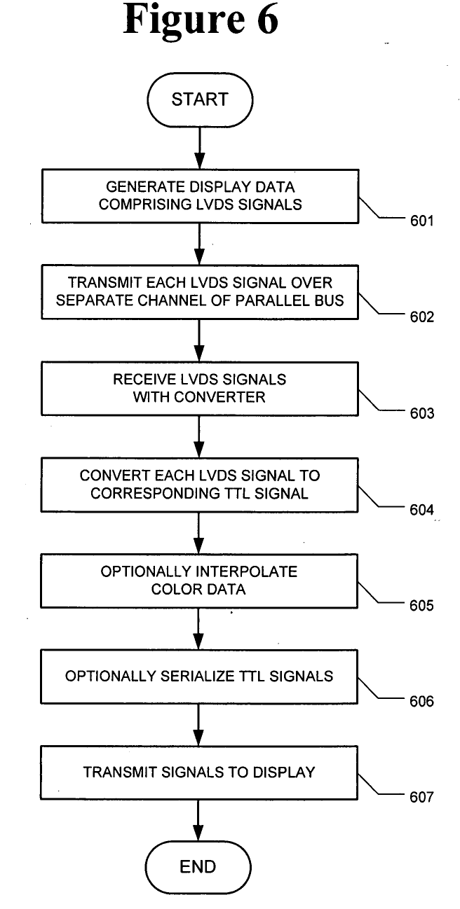

FIG. 6 is a flowchart illustrating a method for displaying data according to one embodiment of the present invention. The method being with step 601, in which display data comprising a plurality of LVDS signals is generated. As described above in greater detail with respect to FIG. 2, the display data may be generated natively in an LVDS format, or may alternatively be generated in a TTL format and subsequently converted to an LVDS format. In step 602, each LVDS signal is transmitted over a separate channel of a parallel bus. In step 603, the LVDS signals is received by a converter, which converts each of the LVDS signals to a corresponding TTL signal in step 604. Step 705, which is optional, involves interpolating the color data to accommodate displays (or other circuitry) configured to accept more channels of color data than were generated in step 601. Step 706 is similarly optional, and involves serializing the TTL signals from step 604, as described in greater detail above with respect to FIG. 5. The method concludes with step 707, in which the signals are transmitted to a display, such as an LCD panel.

While the present invention has been particularly described with reference to the various figures and embodiments, it should be understood that these are for illustration purposes only and should not be taken as limiting the scope of the invention. There may be many other ways to implement the invention. Many changes and modifications may be made to the invention, by one having ordinary skill in the art, without departing from the spirit and scope of the invention.

What is claimed is:

1. A display system comprising:
a controller having a plurality of transistor-to-transistor logic (“TTL”) inputs and a corresponding plurality of low voltage differential signaling (“LVDS”) output pairs, the controller configured to receive display data comprising a first plurality of TTL signals at the plurality of TTL inputs, to convert each of the first plurality of TTL signals to a corresponding LVDS signal, and to output each of the plurality of LVDS signals at one of the plurality of LVDS output pairs;
a bus operatively coupled with the controller, the bus having a plurality of parallel channels, each channel being configured to carry one of the plurality of LVDS signals;
a LVDS-to-TTL converter operatively coupled with the bus, the LVDS-to-TTL converter being configured to receive the plurality of LVDS signals from the bus and to convert each of the plurality of LVDS signals to a corresponding TTL signal in a second plurality of TTL signals; and
a display configured to receive the second plurality of TTL signals from the LVDS-to-TTL converter.

2. The display system of claim 1, wherein each of the parallel channels of the bus includes a twisted pair of cables.

3. The display system of claim 1, wherein the plurality of LVDS signals includes a vertical sync signal, a horizontal sync signal, a clock signal, an enable signal, three red signals, three green signals, and two blue signals.

4. The display system of claim 1, wherein the plurality of parallel channels consists of twelve parallel channels.

5. The display system of claim 4, wherein the bus further includes a thirteenth channel configured as a ground.

6. The display system of claim 1, wherein the display is a liquid crystal display.

7. The display system of claim 1, wherein the first plurality of TTL signals and the plurality of LVDS signals are clocked at a same clock speed.

8. The display system of claim 1, wherein the plurality of LVDS signals and the second plurality of TTL signals are clocked at a same clock speed.

9. The display system of claim 1, wherein the LVDS-to-TTL converter is further configured to serialize the second plurality of TTL signals.

10. The display system of claim 1, wherein the LVDS-to-TTL converter is further configured to interpolate color data in the second plurality of TTL signals.

11. The display system of claim 1, wherein the bus is longer than 10 meters.

12. A display system comprising:
a controller having a plurality of transistor-to-transistor logic (“TTL”) inputs and a corresponding plurality of low voltage differential signaling (“LVDS”) output pairs, the controller configured to receive display data comprising a first plurality of TTL signals at the plurality of TTL inputs, to convert each of the first plurality of TTL signals to a corresponding LVDS signal, and to output each of the plurality of LVDS signals at one of the plurality of LVDS output pairs;
a bus having a plurality of parallel twisted cable pairs, each twisted cable pair being coupled with one of the plurality of LVDS output pairs and being configured to carry one of the plurality of LVDS signals;
a LVDS-to-TTL converter including a plurality of LVDS input pairs, each LVDS input pair corresponding to and coupled with one of the plurality of parallel twisted cable pairs, the LVDS-to-TTL converter being configured to convert each of the plurality of LVDS signals to a corresponding TTL signal in a second plurality of TTL signals and to output the second plurality of TTL signals from a corresponding plurality of TTL outputs; and
a display configured to receive the second plurality of TTL signals from the LVDS-to-TTL converter.

13. A method for displaying data, the method comprising the steps of:
generating display data comprising a first plurality of transistor-to-transistor logic (“TTL”) signals;
converting each of the first plurality of TTL signals to a corresponding low voltage differential signaling (“LVDS”) signal;
transmitting each of the plurality of LVDS signals over a separate channel of a parallel bus with a plurality of parallel channels;
receiving the plurality of LVDS signals from the bus with a TTL-to-LVDS converter;
converting each of the plurality of LVDS signals to a corresponding TTL signal in a second plurality of TTL signals; and
transmitting the second plurality of TTL signals from the LVDS-to-TTL converter to a display.

14. The method of claim 13, wherein each channel of the parallel bus includes a twisted pair of cables.

15. The method of claim 13, wherein the plurality of LVDS signals includes a vertical sync signal, a horizontal sync signal, a clock signal, an enable signal, three red signals, three green signals, and two blue signals.

16. The method of claim 13, wherein the plurality of parallel channels consists of twelve parallel channels.

17. The method of claim 16, wherein the bus further includes a thirteenth channel configured as a ground.

18. The method of claim 13, wherein the display is a liquid crystal display.

19. The method of claim 13, wherein the first plurality of TTL signals and the plurality of LVDS signals are clocked at a same clock speed.

20. The method of claim 13, wherein the plurality of LVDS signals and the second plurality of TTL signals are clocked at a same clock speed.

21. The method of claim 13, further comprising the step of serializing the second plurality of TTL signals.

22. The method of claim 13, further comprising the step of interpolating, with the TTL-to-LVDS converter, color data in the second plurality of TTL signals.

23. The method of claim 13, wherein the bus is longer than 10 meters.
